(19) United States
(12) Patent Application Publication
(10) Pub. No.: US 2010/0257470 A1
(43) Pub. Date: Oct. 7, 2010

(54) PERSONAL PROJECT MANAGEMENT

(75) Inventors: Ismail Ari, Redwood City, CA (US); Riddhiman Ghosh, Sunnyvale, CA (US); Mohamed E. Dekhil, Santa Clara, CA (US); Evren Korpeoglu, Ankara (TR)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/418,484

(22) Filed: Apr. 3, 2009

(51) Int. Cl. G06F 3/048; G06Q 30/00

(52) U.S. Cl. 715/764; 705/14.49

(57) ABSTRACT

An application for personal project management stored on a computer-readable medium, the application includes a workflow engine; a constraint programming solver and a user interface configured to receive input from a user input device to create a workflow model of a personal project. The constraint programming solver is configured to modify the workflow model during both design and run-time by adding suggestions or advertisements. The workflow engine is configured to present the workflow model through the user interface.

### BACKGROUND

People often employ the use of software applications to assist them with their various tasks. Many applications have been developed to help users organize their day-to-day activities and personal projects. Beyond simple to-do lists, these applications typically use the workflow model. A workflow is a model depicting the real work performed by an individual or group of individuals. Workflows have been developed for many project scales, from heavy corporate projects to lightweight individual tasks. Workflows may include the organization of resources, assigned workloads, and information flows.

Many personal project software applications available in the market are designed for a specific project type. For example, there are project management applications for helping a user with the project of preparing a tax return, planning travel, or managing finances. These types of applications must follow a strict task flow which is pre-programmed by the developer. There may be conditional pre-programmed branches throughout the task flow based on questions posed to the user and the responses received. These types of project management applications are limited to the specific type of project for which they were designed.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is an illustrative diagram of various components of a personal project management application with reconfigurable workflow, according to one embodiment of principles described herein.

FIG. 2 shows an illustrative diagram of possible sources which may be involved in designing a personal project workflow, according to one embodiment of the principles described herein.

FIG. 3 is an illustrative flow diagram of a possible method for designing a personal project workflow, according to one embodiment of the principles described herein.

FIG. 4A is an illustration of an illustrative task flow, according to one embodiment of principles described herein.

FIG. 4B is an illustration of an illustrative task flow after an active suggestion has been followed and two new tasks have been added, according to one embodiment of principles described herein.

FIG. 5A is an illustration of an illustrative task flow, according to one embodiment of principles described herein.

FIG. 5B is an illustration of an illustrative task flow after an outsource suggestion has been followed and outsourced tasks have been parallelized with two additional tasks, according to one embodiment of principles described herein.

FIG. 6A is an illustrative diagram showing how advertisements may be implemented into the workflow, according to one embodiment of principles described herein.

FIG. 6B is a set of equations explaining how advertisement revenue may be maximized under set constraints, according to one embodiment of the principles described herein.

FIG. 7 is an illustrative diagram showing the operational flow between the application interface, workflow engine, and the solver, according to one embodiment of principles described herein.

FIG. 8 is an illustration of an illustrative user interface after login for a personal project management workflow application, according to one embodiment of principles described herein.

FIG. 9 is an illustration of an illustrative user interface for a personal project management workflow application, according to one embodiment of principles described herein.

FIG. 10 is a flowchart showing an illustrative method of making a personal project management application according to one embodiment of principles described herein.

FIG. 11 is a flowchart showing an illustrative method of operating a personal project management application according to one embodiment of principles described herein.

Throughout the drawings, identical reference numbers designate similar, but not necessarily identical, elements.

### DETAILED DESCRIPTION

Many workflow applications which exist in the market are designed to assist corporate entities with their projects. In order to maximize efficiency, corporate projects are meticulously planned and must be executed precisely according to plan. Consequently, many project management software applications cater to large corporate projects and are not well suited for individual or personal project management.

There are a variety of software workflow applications which are designed for use on the individual or personal level. However, as noted above, these applications are typically designed for specific types of projects, such a preparing a tax return, booking a flight, etc.

These applications have a predetermined workflow which is set specifically by the developer. The developer for these types of software applications must conform to a strict set of rules and methods for getting the user from the start of the project to the end of the project. In the example of a tax filing application, tax laws and other constraints must be considered when designing the specific project workflow.

Also, such personal project management applications are conventionally only able to help users manage a specific type of project and are not adaptable. For example, an application for helping a user with the project of planning a vacation is only able to help a user plan a vacation. The application cannot easily be changed to serve other personal projects in which the user may wish to engage.

The present specification relates to a workflow application for personal project management which is capable of dynamically managing any type of personal project. The user is able to design a specific project based on predesigned templates, other user's projects, multi-modal information collected from the Internet, or a variety of other sources. During run-time, as the user progresses through the tasks of the project, the project management application may make recommendations for additional steps in the project. The application may also place advertisements throughout the project that are relevant to what the user is trying to accomplish. These targeted suggestions and advertisements can take into account where the user has been, the present status of the user regarding the project, and what the user's end goal is. The project management application may take advantage of workflow software engines which are available such as Microsoft's® Windows® Workflow Foundation (WWF), or the developer may choose to design their own workflow engine. In this specification, a project management application utilizing reconfigurable workflows is discussed.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

According to various illustrative embodiments, the personal project management applications described herein, which make use of configurable workflows, may be referred to as LiteFlows. Throughout this specification, any reference made to the LiteFlows system, LiteFlows service, LiteFlows application, or LiteFlows program is referring to a personal project management software application embodying principles described herein. The LiteFlows application may be a web service or a “Cloud Service.” These terms refer to a deployment and usage model where the end user accesses LiteFlows at a remote server through a web-portal and does not have to install any applications locally. Therefore, IT issues such as operating system compatibility, backup, scalability, security, power management and other complexities are hidden from the end users. The LiteFlows application may be stored on any physical medium for storing computer or processor-readable instructions including, but not limited to, a hard drive, Flash drive or other forms of memory. The LiteFlow application may be executed on a personal computer, server, network or other computing device or system.

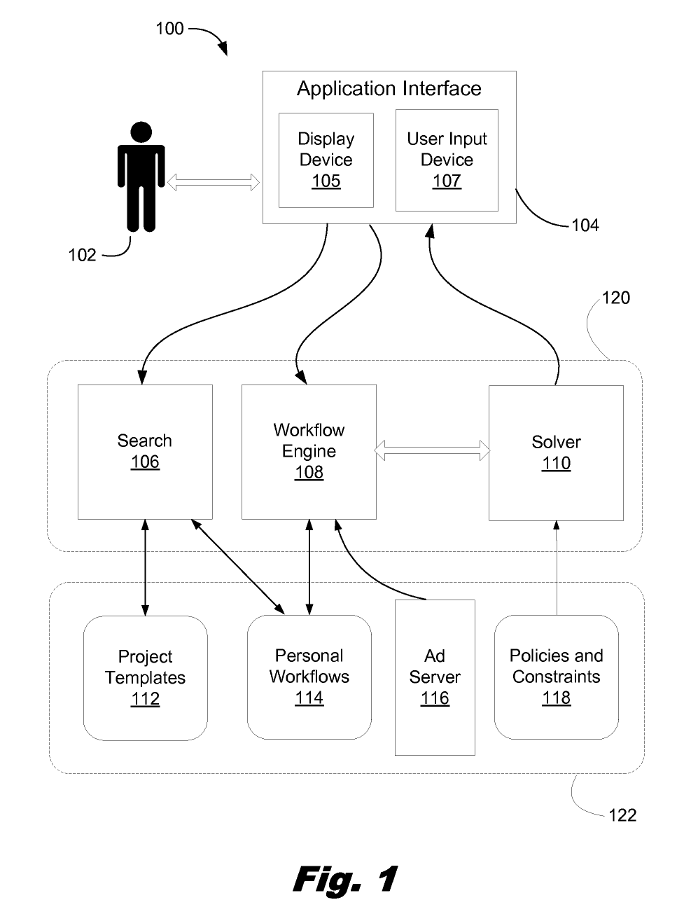

FIG. 1 is an illustrative diagram of various components of the LiteFlows program. A computer system (100), such as a personal computer, server, network or other computing system executes the application or accesses the personal project management application over the Internet or World Wide Web. The user (102) can control the LiteFlows application through an application interface (104). This application interface (104) may include a visual display on a display device (105) in the form of displayed text, graphics, menus, etc. The application interface (104) may also include a user input device (107) including, but not limited to, a mouse, keyboard, touch-sensitive screen, etc. through which the user may enter input. These components of the application interface (104) may be part of a computer device such as a laptop, kiosk, or a mobile hand device. As indicated, in some embodiments, the application interface (104) could be a web-portal, where the application itself does not need to be installed on the user's machine. The user simply accesses the application over the Internet.

In other embodiments, the user could install a program on their machine that will run the LiteFlows application. The installed software application may still, in some embodiments, use the Internet to access various online repositories used to support and run the program.

When a user first starts the application, they may either continue a project which has been created previously, or they may start a new project. The user could search (106) for or navigate to topic-specific project templates (112) or projects created by other users (114). Project templates (112) may be created by the developer of the LiteFlows application or by third party entities. The user may then modify the project to suit his or her personalized needs. Those skilled in the relevant art will be able to provide the necessary tools within the software application to create an efficient project workflow.

In the illustrated example, the program utilizes a workflow engine (108). A software engine is a core part of a program that processes the basic functionality of the program. In an embodiment utilizing a workflow engine, the tasks which a user creates are encoded into parameters which are sent to the workflow engine as function arguments, where the function can be a workflow “code activity,” according to one embodiment. The workflow engine then processes the information sent from the user application and returns a working project workflow using a declarative language such as Business Process Execution Language (BPEL) or Extensible Application Markup language (XAML).

An ad server (116), such as Google® Adwords®, Turn.com, Doubleclick.net or many other similar ad servers, may be used to place advertisements into the workflows which may be related or targeted to the project on which the user is working. A variety of methods and algorithms may be used to place advertisements into the task flow of the project workflow. The placement of such advertisements may be determined by fees or bidding on the part of the advertisers or any method as employed by those skilled in the art of such electronic advertising. A limit on the amount of advertisements placed into the workflows may be put into place to keep users from getting frustrated with too many advertisements and discontinue use of the software application. In one embodiment, constraint programming may be used to determine how to place suggestions and advertisements throughout the project workflow.

A solver (110) may be used to take the workflow created by a user and indicate placement for additional content within the project workflow. This additional content may include, but is not limited to, suggestions and advertisements. The solver (110) may use a set of policies and constraints (118) as determined by the developer. During operation, the solver (110) will update the encoded workflow with positions where additional content should be placed and return it to the workflow engine. The user may then proceed with the project. If at any time during the project, the user makes changes that will affect the workflow, the solver (110) may then update the workflow with positions for additional content depending on the context (e.g. current task, access location, time, day, season, weather, available products and campaigns, etc.) and return it to the workflow engine using the various policies and constraints (118) which may be in place.

In the figure, the boxes (106,108,110) inside of the first dotted box (120) represent various processing components of the LiteFlows service. The boxes (112,114,116,118) inside of the second dotted box (122) represent various repositories or data storage units accessible through LiteFlows program. As indicated, these components may reside on the local machine or may be available over a network.

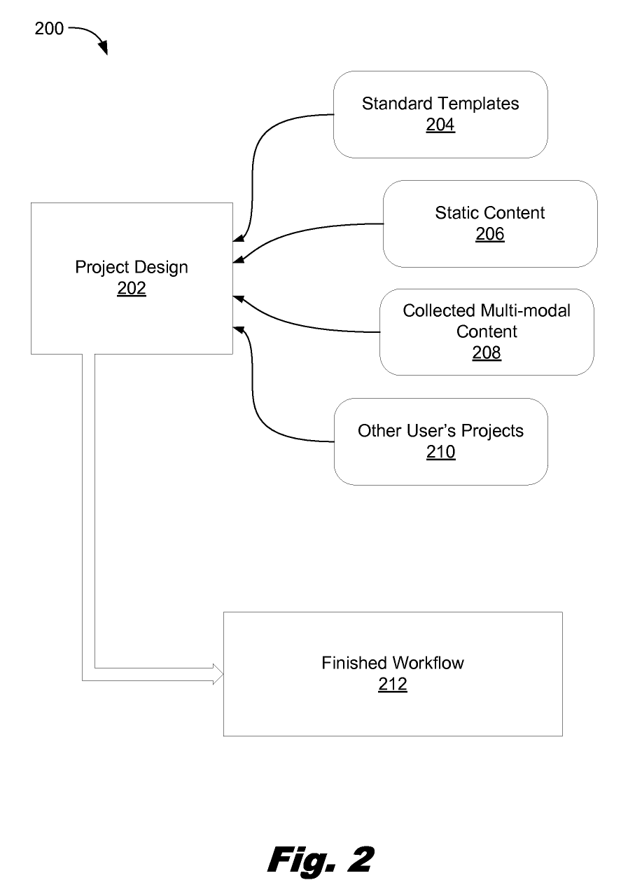

FIG. 2 shows an illustrative diagram (200) of possible sources of workflow component which may be utilized in creating or designing a personal project workflow. In one embodiment, the user would start by creating a customizable project from scratch. The LiteFlows application may come with tools to design a project from scratch, creating each task individually. Anything that a user enters manually to the project will be referred to as static content (206) throughout this specification.

The user may also search for templates (204) which relate to a particular type of project, such as a home improvement project. These templates can be created by the developer or other third party entities. The user may then add any additional static content (206) to the template to customize the project to their individual needs.

The user may also have the option to search for existing workflows for projects that other users have already created, shared, and/or published (210). Again, the user may have the option to add static content (206) or multi-modal content such as additional tasks. The user may also be able to take away tasks or content, either static or multi-modal, which are not relevant to their specific project.

The user may also collect multi-modal information from the Internet such as pictures, videos, or text which may be relevant to their project. Collection of multi-modal information can be done by select-copy-paste or select-drag-drop operations and maintaining the links to the original content or downloading the multi-modal content to the personal workflows (114) project space. The templates (204), static content (206), multi-modal content (208), and other user's projects (210) can all be used to make a finished project workflow (212).

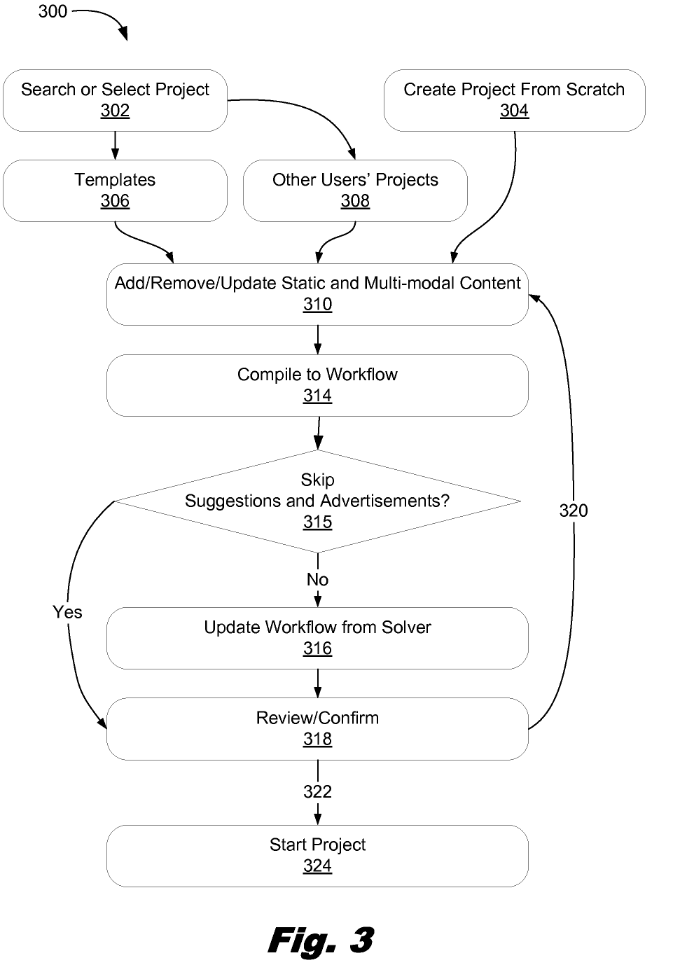

The LiteFlows application will take all the information collected from the user and form a completed project workflow that is ready to be executed. FIG. 3 shows a flow diagram (300) of an illustrative method for creating a project workflow. As mentioned above, the user can either choose to search (302) for a project template (306), a past project already owned by that user, other users' projects (308), or create a project from scratch (304). The user may then add, remove or update static or multi-modal content (310) as desired to customize the project workflow to their specific project.

The LiteFlows application will then compile the information into a workflow (314) format familiar to a workflow engine (108, FIG. 1). In one embodiment, the user may choose to opt out of having suggestions and advertisements placed into the workflow. The user would be prompted to skip the placement of suggestions and advertisements (315). If the user chooses to skip the placement of advertisements and suggestions, then they will be presented with an overview of their project (318) and may continue from there. If the user does not opt out of suggestions and advertisements, the workflow engine can then send the workflow to a solver (110, FIG. 1) which will use various policies and constraints (118, FIG. 1) to arrange the workflow with suggestions and advertisements dynamically modified at run-time along with the project tasks (316). The user may then be presented with an overview of the project workflow (318). If the user is satisfied with the project workflow, the user may continue (322) and execute the project workflow. The user then starts to work on the project (324). If the user wishes to make additional adjustments, they may have the option to go back (320) to adding static content (310).

As noted above, with most workflow applications, once the workflow has been executed, it does not change. There may be branches and conditions which allow the workflow to take variable paths, but the workflow is set as it was created by the developer. The LiteFlows application is designed to allow the workflow to change dynamically during run-time. If the user or the LiteFlows system wish to add additional tasks, they may do so.

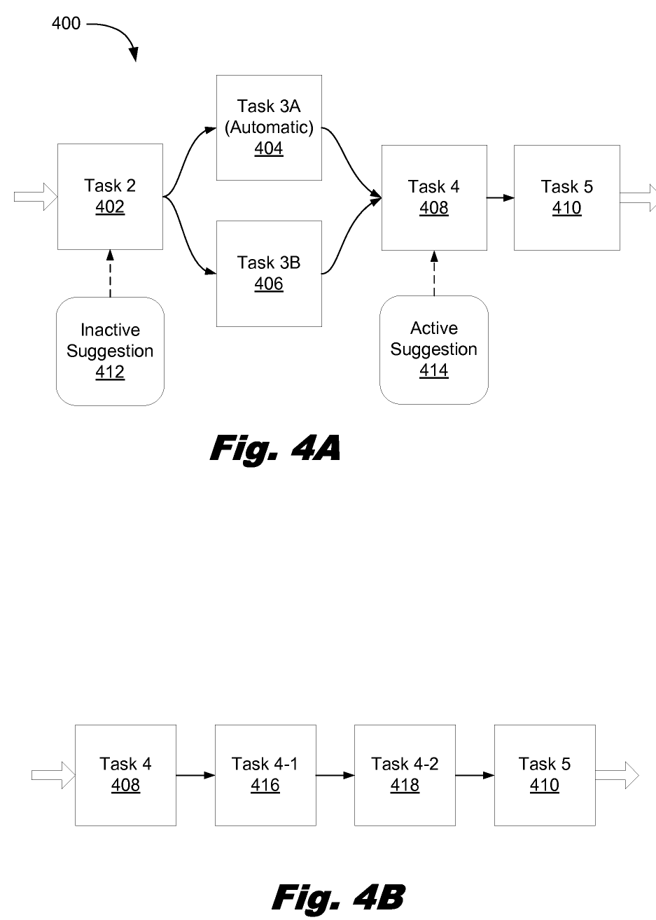

FIG. 4A is an illustration (400) of an illustrative workflow composed of individual tasks. Most workflows follow a sequential pattern. This sequential pattern may also have parallel paths. The figure shows a task flow starting at task 2 (402). The flow then proceeds to the next task flow in which two tasks, task 3a (404) and task 3b (406) are done in parallel. Some tasks may be done automatically as is the case with task 3a (404). An example of an automatic task would be to update information from the Internet, send out an email, or any other task which can be done electronically. Task 3b (406) could be any task the user needs to do while the automatic task (404) is being done electronically. Parallel tasks are not limited to one being automatic. There may be several tasks of any type in parallel which a user or supporting computer system may need to be doing at the same time.

In one embodiment, certain suggestions and/or recommendations which are relevant to the project may be placed throughout the workflow. Suggestions may either be active or inactive. Throughout this specification, active suggestions will refer to suggestions which will modify the tasks of the workflow when accepted by the user. Inactive suggestions will refer to suggestions which will not modify the tasks of the workflow. An inactive suggestion (412) could be a simple reminder to the user regarding their current task. Active suggestions (414) may also be placed along with specific tasks in the task sequence. In the figure, an active suggestion is assigned to task 4 (408). The user may wish to ignore this suggestion and move on to task 5 (410). Alternatively, the user could accept the suggestion. When an active suggestion is consumed, it may change the task sequence of the workflow by adding any number of additional tasks.

FIG. 4B is an illustration of the illustrative workflow after an active suggestion (414) has been accepted. An active suggestion may ask the user if they want to do some additional tasks before they proceed to the next task. If the user chooses to accept the suggestion and invoke the additional tasks, the workflow is then updated and any amount of additional tasks may be added to the task sequence. Thus, the workflow is reconfigurable and can be dynamically modified during run-time. In the figure, when the user chooses to accept the active suggestion (414), two additional tasks (416, 418) are added. These tasks are placed after task 4 (408) and before task 5 (410).

As indicated, an inactive suggestion generally does not modify the sequence of tasks in the workflow. An example of an inactive suggestion in the case of a home improvement project that includes painting might be something like: “Remember to stir the paint.” These inactive suggestions may assist with the performance of an existing task without modifying the task sequence or structure and can be anything that will help the user with the project. The source for such suggestions can be other users' projects, developer suggestions, or any other source able to be developed by those skilled in the relevant art.

An example of an active suggestion in the case of the same project would be to say something like: “Do you wish to sand and treat the wood before painting?” If the user accepts the suggestion, the LiteFlows application, including the constraint programming solver, will update the workflow and one or more additional tasks as well as potential advertisements will be added to the workflow without violating the constraints. For example, the workflow may be modified to include a sanding task followed by a wood staining task. After the user has completed the additional tasks, he or she may then proceed to the painting tasks.

In some embodiments, suggestions will depend on real time factors. For example, the LiteFlows application could have access to the weather data for the location of the user. If a user's current task involves outdoor work and the weather is poor, a suggestion may say something like: “You may want to wait for better weather.” Real-time suggestions are not limited to weather tracking. Any environmental or external factor which could affect the user's project or task in any way may be reported to the user through suggestions throughout the workflow. Those skilled in the relevant art are able to take advantage of various resources available to report relevant external conditions to a user.

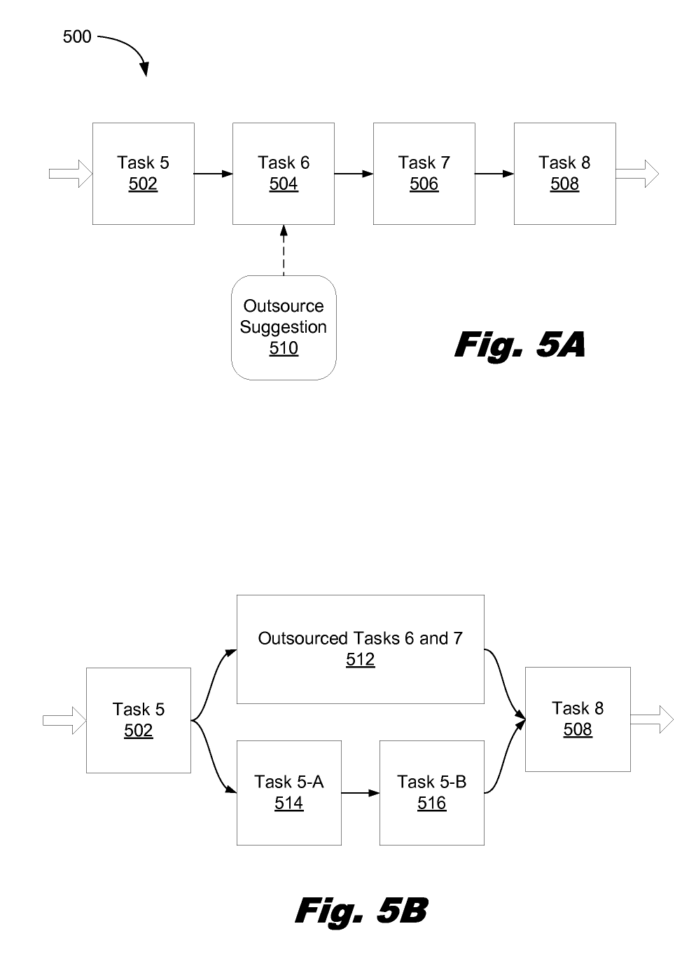

Another type of active suggestion could be for the user to outsource one or more tasks. FIG. 5A depicts an illustrative workflow with an outsource suggestion. In the figure, an outsource suggestion (510) is associated with task 6 (504). This suggestion may be to outsource tasks 6 and 7 (504, 506). The user may either choose to do these tasks personally or follow the outsource suggestion and have someone else do them. Based on tracking of the task completion time in previous personal projects this suggestion may be done to save users time and money. If the user chooses to outsource the tasks, the workflow will be updated and the task sequence changed.

FIG. 5B is an illustration of an illustrative task flow after an outsource suggestion has been followed. In some cases, the LiteFlows application can suggest parallel tasks which the user may do while waiting for the outsourced tasks to be completed. Depending on the specific project, the user may have to wait until the outsourced tasks are completed before working on any other part of the project. In the figure, the outsourced tasks are replaced with a task box (512) showing that tasks 6 and 7 (504, 506) have been outsourced. The personal project application may also add additional tasks (514, 516) while waiting for the outsourced tasks (504, 506) to be completed. Once the outsourced tasks are completed, the user may then proceed to the next task (508).

If, for example, the user is doing some restoring work on a car engine for a project, an outsource suggestion could say something like: “Would you like to hire John the mechanic to do these steps for you?” In one embodiment, John the mechanic may place his advertisement in relevant workflow slots through a bidding process for relevant keywords such as “car restoration.” If the user chooses to outsource a few tasks to a mechanic, the workflow would be altered as shown in FIG. 5B. There may or may not be steps which the user could do while waiting for the outsourced task(s) to be completed. A user may also have more than one project. In such case, the user could work on another project until the outsourced tasks were completed if so desired.

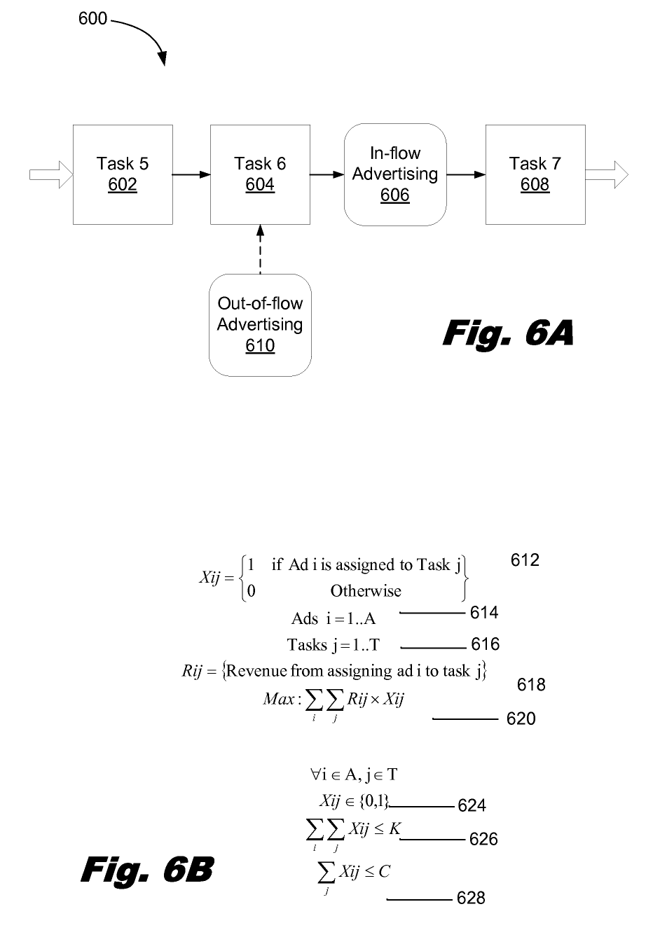

FIG. 6A is an illustrative diagram (600) showing how advertisements may be implemented into the workflow. Advertisements are one embodiment of revenue-generating types of recommendations. As the user proceeds through a sequence of tasks, advertisements may be placed inside the task flow (606) or outside the task flow (610). In some embodiments, advertisements placed inside the task flow (606) would have a similar appearance as a task itself. As the user progresses through the task sequence, they would come to a task representing advertising which has been inserted by the software application. In the figure, this type of advertisement comes after task 6 (604) and before task 7 (608). After the user sees that the next task is an advertisement, they can simply move on to the next task. An advertisement which is not in the task flow may be displayed in some banner that is part of the application interface (104, FIG. 1) for the LiteFlows application. These out of flow advertisements may be targeted to specific tasks or to the project in general.

Any method for placing advertisements may be used. Some advertisements are charge per impression; that is, the advertiser pays to have the user view the ad whether they click on it or not. Other advertisements are charge per click; that is, the advertiser pays only if the user clicks on the advertisement. Yet, other advertisements are charge per action; that is, the advertiser pays only if the user accepts the offer and a trackable action is present, the action denoting successful completion of business has occurred. Generally, a type of bidding occurs where the advertisement which the user will see at a specific time is the advertisement for the advertiser is willing to pay/provide the most money. It will be readily apparent to those skilled in the relevant art how auctions are made. Techniques include but are not limited to Generalized Second Price (GSP) aka Vickrey auctions or Vickrey-Clarke-Groves (VCG) type of auctions.

An issue with using advertisements with an application is that if there are too many advertisements, a user may become frustrated and discontinue use of the application. There are statistical formulas which are developed to maximize revenue by finding the maximum amount or ratio of advertisements placed into a workflow while limiting user attrition. In one embodiment of the LiteFlows application described herein, a set of constraints (118, FIG. 1) may be used to determine the amount or ratio of advertisements placed into a workflow. A constraint programming solver (110, FIG. 1) may then be used to solve the problem of how many advertisements to place into the workflow. The workflow engine (108) can then present advertisements as tasks within the project workflow or as other portions of the application interface.

Constraint programming is a style of programming where relations between variables are stated as constraints. Constraint programming specifies properties of a solution. Using constraint programming to determine appropriate advertisement placement will allow greater flexibility and efficiency. Those skilled in the relevant art are able to determine the necessary constraints and how to best implement them. For example, the constraints could include total number of advertisements, advertisement density, ordering, grouping and/or any other criteria.

FIG. 6B is a mathematical description of how advertisement revenue could be maximized using constraints. As mentioned above, the placement of advertisements may be formulated as a type of constraint satisfaction problem referred to a “resource assignment” problem. These assignment problems fall under the category of binary integer programming (BIP) wherein all unknown values take on an integer value of either 0 or 1. The first line (612) indicates that the variable Xij will be assigned the value 1 if advertisement i is assigned to task j and the value zero otherwise. Line 614 indicates that the variable i ranges from one to A (the total number of advertisements). Line 616 indicates that the variable j ranges from 1 to T (the total number of tasks). Line 618 indicates that the variable Rij denotes the amount of revenue that would be gained from assigning advertisement i to task j. The goal is to maximize the total revenue as described in line 620 by making the optimal Xij placements under given constrains.

It will be readily apparent to those skilled in the art how line 622 defines the set for variables i and j. Line 624 indicates that the Xij matrix takes values only from the set {0,1}, where i E A represents an ad i from a set of relevant ads A and a task j from a set of tasks T in the project. Line 626 shows a constraint which places a limit (K) on the total number of advertisements (i.e., 1's) which can be placed in a project. Line 628 shows a constraint which places a limit (C) on the total number of advertisements which can be assigned to a single task. As mentioned above, the exact limits (C and K) can be defined to limit user attrition.

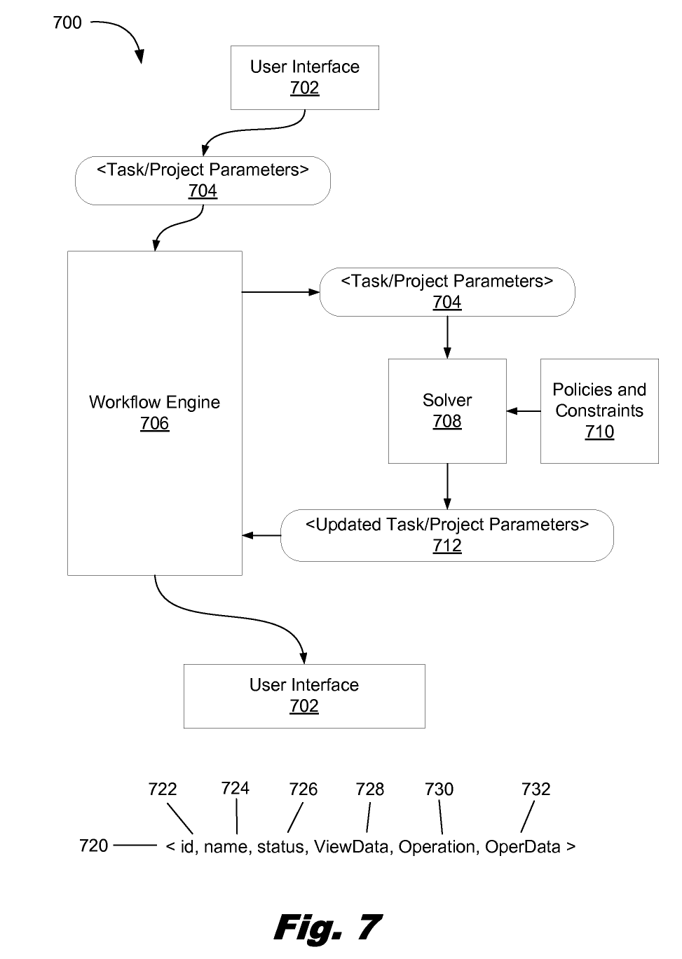

FIG. 7 shows the relation between the LiteFlows application interface (702) for project creation, workflow engine (706), and solver (708). The diagram (700) starts with the application interface (702). Through the interface (702), a user may create a project workflow and customize it to suit a specific project. The LiteFlows program takes the data representing parameters of the project workflow and puts it into a form which can be processed by a workflow engine. This form is typically a set of parameters (704) which are passed into the workflow engine (706). The workflow engine may then take those parameters and formulate a workflow object. An example of what these parameters (720) may look like is shown at the bottom of FIG. 7. The LiteFlows program will need to update the workflow upon completion of design by the user. LiteFlows may also update the workflow after each session (logout and login) to provide relevant recommendations for the current or changing conditions. The update may add additional tasks, suggestions, and advertisements derived from a variety of sources.

The project parameters are sent to a solver (708). In some embodiments, the solver (708) takes the parameters (704) and arranges them into a matrix format. In other embodiments, the LiteFlows application itself may do the matrix arrangement. The solver can then use a set of policies which represent the objective functions (e.g. maximizing revenue) and constraints (710) to solve the matrix. By solving the matrix, it is meant that the parameters are rearranged so as to fit the criteria (policies and constraints) given by the developer. For example, as mentioned before, it is important not to have too many advertisements in order to limit user attrition. The constraints can be set to satisfy the users' tolerance for advertisements. The solver makes selections from a large pool of relevant paying advertisements so that the goal of maximizing revenue under the given set of constraints is satisfied.

After the solver (708) has reconfigured the matrix, it then sends the updated parameters (712) back to the workflow engine where they may be presented as an updated executable workflow to the user through the interface (702). When a user makes a change to the workflow as they are proceeding through their project, the workflow engine (706) can send the workflow to the solver again to update the workflow. Most personal projects will not be completed in one session. Therefore, the workflow engine (706) will also send the workflow to the solver for update after each login or when conditions significantly change. Updates made may include adding additional content or accepting a suggestion, recommendation, or advertisement. Those skilled in the relevant art will be able to develop the necessary algorithms and constraint programming methods to enable the solver to properly reconfigure the workflows to match the desired criteria.

In some embodiments, a project could be represented by parameters. These project parameters could include identification (ID), name, completion status, project begin and end times, and a list of all the tasks involved. Each task involved with the project could initially inherit the properties of the project it belongs to can extend or modify these default parameters. In addition, tasks can have their own unique parameters. These concepts will be apparent to one skilled in the art of object-oriented design, specifically inheritance and polymorphism. An example of a set of task parameters is shown at the bottom of the figure (720). A set of task parameters could include an ID number (722) to identify the task. In one embodiment, the ID number could be a globally unique identifier (GUID) to uniquely identify tasks across projects and track relations among user projects or track usage of templates. The GUID can be modified when a task is modified. Other parameters may include but are not limited to the name of the task (724), the status of the task (726) meaning whether it has been completed or not, and finally the start and end times of the task (726). ViewData (728) could represent multi-modal content within the task. Operation (730) could be an operation which the task could perform electronically such as fetch content from the Internet or retrieve email, or it can be a description of one or more manual tasks. OperData (732) could be a set of data relevant to the task. An example could be a web address for fetching web content (a URL or URI). The parameters discussed above are simply an example of how task parameters may be implemented. Any method developed by those skilled in the relevant art to represent task and project parameters may be used.

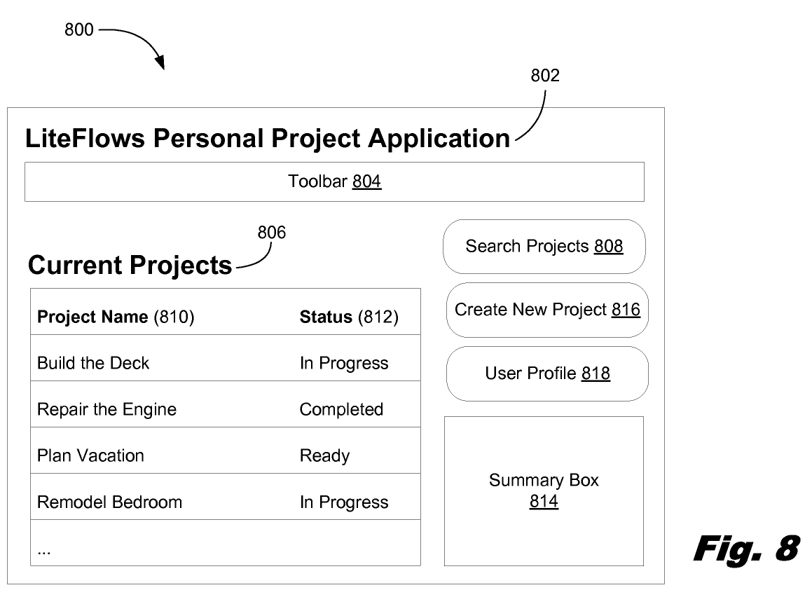

FIG. 8 is an illustration of an illustrative user interface (800) for the LiteFlows application when a user first logs in. The exact interface which the LiteFlows application uses when a user first logs in is not limited to the one shown in the figure or anything similar to it. Any interface as determined by those skilled in the relevant art may be used.

In the illustrated embodiment, the LiteFlows title (802) or any other title given to the workflow application described in this specification is displayed. Below that would be a toolbar (804) containing a variety of tools which the developer deems necessary or useful for this application.

On the left side of the interface and below the toolbar is a window containing a table of current projects (806). This table includes the name of each project (810) and its status (812). Some illustrative projects which are shown in the figure are build the deck, repair the engine, plan vacation, and remodel bedroom. The status (812) is shown to the right of each project name (810). Different statuses could include but are not limited to completed, in progress, or ready (indicating the project has been created but has not yet been started). Project completion status and completion durations are measured and thus provide the basis for active or inactive suggestions.

On the right side of the interface, a button (808) is placed allowing the user to search for additional projects. As mentioned above, the user could search for previously created project templates or projects created by other users. The user could also create a project from scratch by pressing the “Create New Project” (816) button. A “User Profile” button (818) invokes options for the user to enter demographic information and ad opt-in/opt-out decisions which are used for targeted ad placement decisions.

Below these buttons is a summary window which gives an overview of the project selected from the current project window (806). This overview could include but is not limited to such information as project creation date, planned completion time, a summary or description of the project, and an overview of the tasks associated with the project and a summary or description of the project.

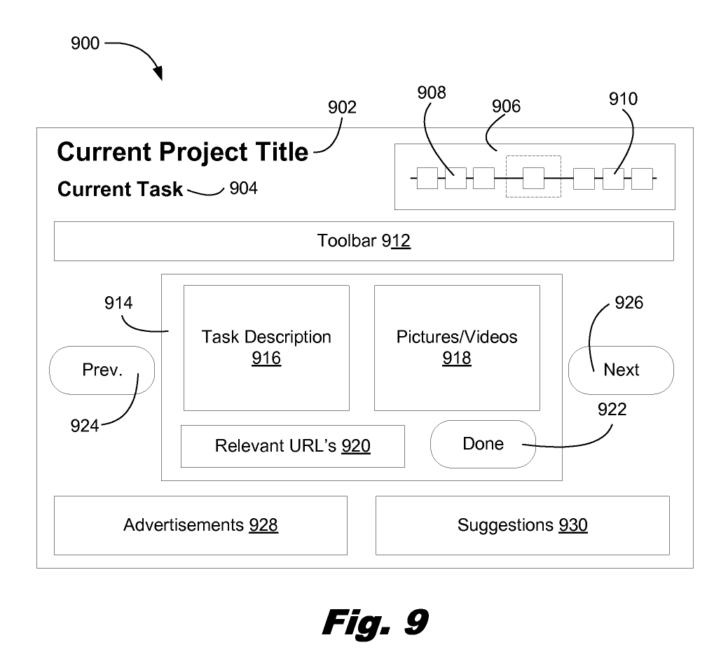

FIG. 9 is an illustration of an illustrative user interface (900) for the LiteFlows application. The user interface for the personal project management application described in this specification is not limited to the one shown in the figure or anything similar to it. Any interface as determined by those skilled in the relevant art may be used.

In the illustrated embodiment, the interface would display the project title (902) at the top. The current task title (904) could be displayed directly beneath the project title (902). On the top right, a broader view of the current task (906) could be displayed. This could be a sliding window of tasks including a few tasks previous to the current task (908) and a few tasks which will follow the current task (910).

In the illustrated example, a toolbar (912) is provided below the current task title (904). The toolbar may contain a variety of tools and menus which the developer feels will be necessary or useful to the application.

Below the toolbar (912), the main window (914) displays the current task. In the illustrated example, this includes a description of the task (916), pictures or videos (918) relevant to the task, and URL's (920) relevant to the task. There could also be a button (922) that the user may click on when they have completed the task, accepted an offer, or just skipped it. The multi-modal information displayed with the task may have come from static content created by the user, or additional content as created by the LiteFlows application.

To the left of the main window (914) could be a button (924) allowing the user to view the previous task. To the right of the main window (914) could be a button (926) allowing the user to view the next task. At the bottom left could be a banner (928) that displays advertisements which may be relevant to the current task or to the project in general. These advertisements would be out-of-flow advertisements (610, FIG. 6) as mentioned previously. In the case of an in-flow advertisement (606, FIG. 6), the advertisement would be displayed in the main window (914).

In the bottom right is a box that may display suggestions or recommendations relating to the current task or the project in general. Suggestions or recommendations may also be placed in the main window (914). These may either be the inactive (412, FIG. 4) or active (414. FIG. 4) suggestions as discussed previously.

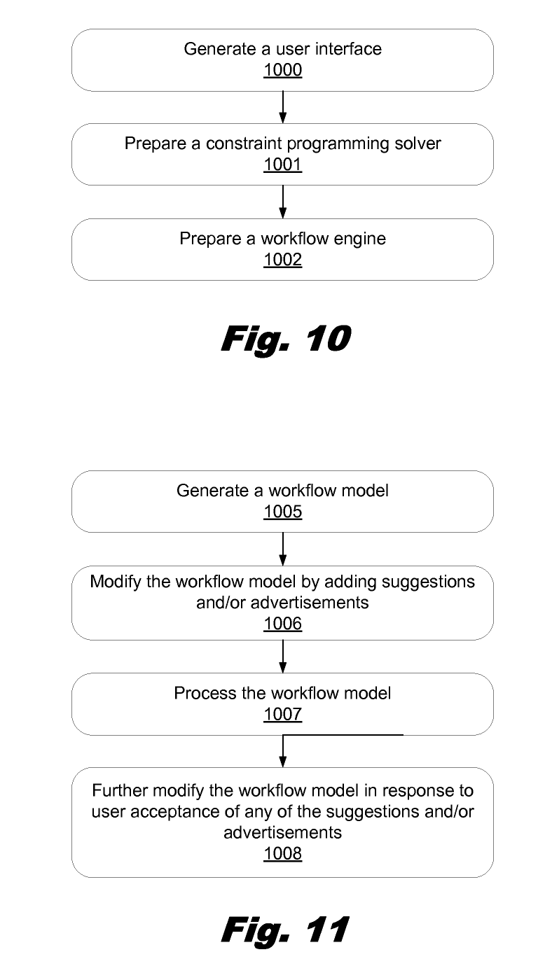

FIG. 10 is a flowchart showing an illustrative method of deploying the LiteFlows personal project management application in a new computing site according to one embodiment of principles described herein. As shown in FIG. 10, the method includes configuring a user interface (1000) configured to provide output to a display device and receive input from a user input device so as to allow a user to define a workflow model for a personal project; and installing a constraint programming solver (1001) configured to solve resource assignment problems efficiently and indicate placement for the addition of suggestions or advertisements to the workflow model based on content of the workflow model.

The method may further include installing and configuring a workflow engine (1002) to execute the workflow model that is presented to the user through the user interface. This workflow engine may also dynamically modify the workflow model based on user acceptance of any of the suggestions or advertisements.

FIG. 11 is a flowchart showing an illustrative method of operating a personal project management application after it is created and deployed according to one embodiment of principles described herein. As shown in FIG. 11, the method includes generating a workflow model (1005) for a personal project using a user interface that is configured to provide output to a display device and receiving input from a user input device. The method further includes modifying the workflow model (1006) by adding suggestions or advertisements with a constraint programming solver configured to add the suggestions or advertisements to the workflow model based on content of the workflow model.

The method may further include processing the workflow model (1007). This may include presenting the workflow model in any of a number of different ways using a workflow engine and user interface.

The method may also include further modifying the workflow model (1008) in response to user acceptance of any of the suggestions or advertisements added to the workflow model. This modification may including adding, deleting or reordering tasks of the workflow model.

In summary, the LiteFlows application allows users to easily modify and customize their projects both in the design phase and the run-time phase. A user is able to create a project of any type as opposed to a specific type of project. The user is able to design and customize a project to fit specific needs. The end users of the system do not needs to install or tune operating systems, web servers, databases or configure any specific programs when the LiteFlows application is provided as a service. They may use templates provided by the application developer or other third parties. They may also collect multi-modal content from the Internet or any other suitable source to synthesize a rich description of their personal project task by task. The LiteFlows program is able to give the user relevant suggestions based on past, present, and/or future tasks or projects and other users' past projects. Advertisements within the workflow also target the user's needs based on past, present and/or future tasks. The workflow model is able to be modified during run-time based on suggestions or advertisements the user chooses to accept. The LiteFlows program uses a set of policies and constraints and a constraint programming solver to modify the personal project workflow model by adding recommendations, specifically suggestions and/or advertisements.

An application embodying the principles described in this specification is not limited to the types of projects and specific projects mentioned. The examples mentioned in the description are for illustrative purposes only. Further, the invention is not limited to the ways of which suggestions, recommendations, and advertisements modify the workflow as mentioned specifically in this specification.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. An application for personal project management stored on a computer-readable medium, the application comprising;
a workflow engine;
a constraint programming solver; and
a user interface configured to receive input from a user input device;
in which the application is configured to respond to user input through said user interface to create a workflow model of a personal project;
said constraint programming solver is configured to modify the workflow model during both design and run-time by adding suggestions or advertisements;
said workflow engine is configured to present said workflow model through said user interface.

2. The application of claim 1, in which said user interface comprises a web-portal.

3. The application of claim 1, in which said workflow model comprises a number of tasks, said constraint programming solver being configured to limit a ratio of said suggestions and advertisements to said number of tasks.

4. The application of claim 1, in which said workflow engine is configured to access a project template and receive user input modifying said project template to produce said workflow model.

5. The application of claim 1, in which said constraint programming solver is configured to access sources of news and real time information and produce said suggestions or advertisements based on said news and real time information.

6. The application of claim 1, in which said workflow engine is configured to modify said workflow model during run-time in response to user acceptance of said suggestions or advertisements.

7. A method of making a personal project management application, said method comprising:
generating a user interface configured to receive input from a user input device defining a workflow model for a personal project;
preparing a constraint programming solver configured to add suggestions or advertisements to said workflow model based on content of said workflow model; and
preparing a workflow engine configured to present said workflow model through said user interface including said suggestions and/or advertisements and to dynamically modify said workflow model based on user acceptance of any of said suggestions or advertisements.

8. The method of claim 7, in which said workflow model comprises a number of tasks, said method further comprises limiting a ratio of said suggestions and advertisements to said number of tasks.

9. The method of claim 7, further comprising configuring said workflow engine to access a project template and receive user input modifying said project template to produce said workflow model.

10. The method of claim 7, further comprising configuring said constraint programming solver to access sources of news and real time information and produce said suggestions or advertisements based on said news and real time information.

11. The method of claim 7, further comprising configuring said workflow engine to modify said workflow model during run-time in response to user acceptance of said suggestions or advertisements.

12. A method of operating a personal project management application, said method comprising:
generating a workflow model for a personal project using a user interface configured to receive input from a user input device; and
modifying the workflow model by adding suggestions or advertisements with a constraint programming solver configured to add said suggestions or advertisements to said workflow model based on content of said workflow model.

13. The method of claim 12, further comprising presenting said modified workflow model to a user through said user interface.

14. The method of claim 13, further comprising dynamically modifying said workflow model based on user acceptance of any of said suggestions or advertisements.

15. The method of claim 12, further comprising accessing sources of news and real time information and producing said suggestions or advertisements based on said news and real time information.
